(19) United States
(12) Patent Application Publication
(10) Pub. No.: US 2013/0125162 A1
(43) Pub. Date: May 16, 2013

(54) Deferring Committing Downloads Until Device has Satisfied Installation Requirements

(71) Applicants: Altan John Stalker, Lawrenceville, GA (US); Shuhua Zhang, Duluth, GA (US); Russell Leake, Atlanta, GA (US); Janwun Lee, San Jose, CA (US)

(72) Inventors: Altan John Stalker, Lawrenceville, GA (US); Shuhua Zhang, Duluth, GA (US); Russell Leake, Atlanta, GA (US); Janwun Lee, San Jose, CA (US)

(73) Assignee: Cisco Technology, Inc., San Jose, CA (US)

(21) Appl. No.: 13/294,207

(22) Filed: Nov. 11, 2011

(51) Int. Cl. H04N 7/16

(52) U.S. Cl. 725/25

(57) ABSTRACT

Operating software commitment may be provided. First, a subscriber device may be configured using a factory software and a service provider software may be downloaded. Next, it may be verified that the subscriber device is properly configured. In response to verifying that the subscriber device is properly configured, the service provider software may then be committed to the subscriber device.

### BACKGROUND

A set-top box (STB) or set-top unit (STU) is an information appliance device that generally contains a tuner and connects to a television set and an external source of signal, turning the signal into content which is then displayed on the television screen or other display device. A cable converter box or television converter box is type of set-top box that is an electronic tuning device that transposes/converts any of the available channels from a cable television service to an analog RF signal on a single channel, usually VHF channel 3 or 4. The device allows a television set that is not “cable ready” to receive cable channels.

### BRIEF DESCRIPTION OF THE DRAWINGS

The accompanying drawings, which are incorporated in and constitute a part of this disclosure, illustrate various embodiments of the present disclosure. In the drawings:

FIG. 1 is a block diagram of an operating environment including a subscriber device;

FIG. 2 is a block diagram of the subscriber device; and

FIG. 3 is a flow chart of a method for committing software.

### DETAILED DESCRIPTION

### Overview

New software may exist on a device, but only becomes active when committed. Operating software may decide to commit new software based on various criteria. First, a subscriber device may be configured using a first code image (e.g. factory software) and a second code image (e.g. service provider software) may be downloaded. Next, it may be verified that the subscriber device is properly configured. In response to verifying that the subscriber device is properly configured, the second code image may then be committed to the subscriber device.

Both the foregoing overview and the following example embodiment are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiment.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

A subscriber device, such as a set-top-box (STB), may be preconfigured with a first code image. When the subscriber device is installed at a customer premises, the first code image may be executed. Once executed, the first code image may only be operative to perform a few limited functions. These limited functions may serve to configure the subscriber device. For example, the first code image may be configured to communicate with a service provider and authorize the subscriber device to receive services from the service provider. In addition, the first code image may determine whether the subscriber device is within an operating environment suitable for receiving these services. Code image (e.g. first code image and second code image) may comprise software configured to make the subscriber device work, such as an operating system, drivers, applications, etc.

However, because the first code image may only serve to configure the subscriber device, the subscriber device may still require a second code image to properly receive the authorized services from the service provider. Thus, the first code image may be configured to download the second code image from the service provider. In turn, the service provider's second code image may enable the subscriber device to receive the various subscriber services that the subscriber device has been authorized to receive.

The first code image may be operative to configure the subscriber device and download the second code image in parallel. For example, while the first code image may configure the subscriber device, the first code image may simultaneously download the second code image in a background operation. Then, once the first code image determines that the subscriber device is properly configured, the first code image may cause the second code image to be committed on the subscriber device. Once committed, the second code image may become activated on the subscriber device upon a reboot of the subscriber device.

The first code image may determine that the subscriber device is properly configured when the subscriber device satisfies, for example, a set of predetermined conditions. These conditions may comprise, but not be limited to, for example, in-band signal strength, out-of-band signal strength, Internet Protocol connectivity, CableCARD functionality, coaxial and Ethernet cable connectivity, network bandwidth availability, among other operating environment checks.

When the conditions are met and the second code image is committed to the subscriber device, the subscriber device may be enabled to receive the provisioned services upon reboot of the subscriber device. These provisioned services may comprise, for example, a media guide, television programming, video-on-demand, as well as other services for which the subscriber of the subscriber device may be authorized to receive.

Until the second code image is committed to the subscriber device, a reboot of the subscriber device would not cause the second code image to be activated. In this way, the subscriber device may be power cycled during configuration without triggering an activation of the downloaded second code image.

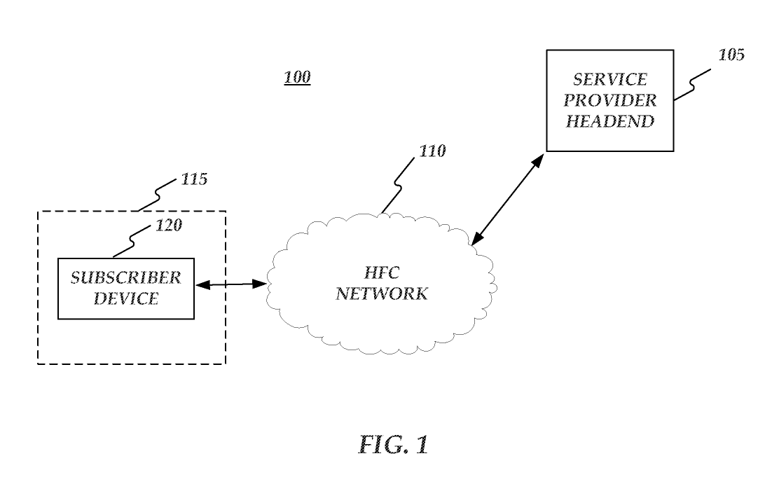

FIG. 1 is a block diagram of an operating environment 100. As shown in FIG. 1, environment 100 may include a service provider headend 105, a Hybrid-Fiber-Coaxial (HFC) network 110, and customer premises equipment (CPE) 115. CPE 115 may comprise a subscriber device 120. Service provider headend 105 may comprise a device controlled by a telecommunications service provider and configured to provide, for example, digital cable television, analog cable television, landline communication, wireless communication, Internet, and other broadband services. The service provider may provide these services to CPE 115 over HFC network 110.

HFC network 110 may comprise, for example, a broadband network capable of service transmission at various protocols. CPE 115 may include various subscriber devices (e.g., subscriber device 120) on various different platforms. For example, subscriber device 120 may comprise a personal computer, a STB, a video-game console, a mobile communications device, a handheld device, or any other computing device capable of communicating with service provider headend 105 over HFC network 110.

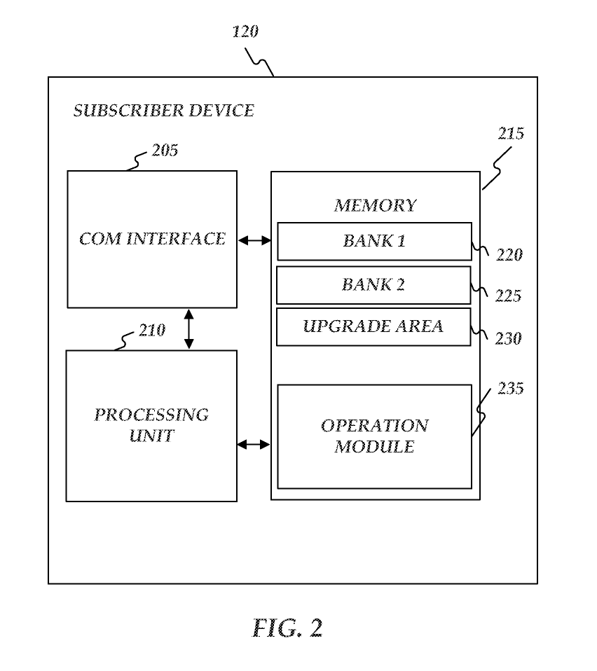

FIG. 2 is a block diagram of subscriber device 120. Subscriber device 120 may comprise a communication interface 205, a processing unit 210, and a memory 215. Memory 215 may be a persistent storage device, such as flash memory or a hard drive. Memory 215 may comprise a first memory bank 220, a second memory bank 225, an upgrade area 230, and an operation module 235. First memory bank 220 and second memory bank 225 may be persistent memory banks. Communication interface 205 may be configured for communicating with, for example, service provider headend 105 over HFC network 110. Processing unit 210 may be in operative communication with communication interface 205 and memory 215. Memory 215 may include, in various embodiments, multiple memory banks.

First memory bank 220 may be used as a current memory bank storing a currently operating image of software for subscriber device 120. The currently operating image may comprise the first code image or the second code image, depending on a state of subscriber device 120. For example, if subscriber device 120 has been configured and the second code image has been activated, the current memory bank may comprise the second code image. Second memory bank 225 may be used as a previous memory bank, storing, for example, a previous operating image of software such as the first code image. Second memory bank 225 may store the first code image as a fall-back measure in case of corruption or operation failure of the currently operating image. In some embodiments, the first code image may comprise subscriber specific information.

In various embodiments, a memory bank comprising the currently operating image of the software may be considered a current memory bank. The memory bank comprising the previously used software may be considered the previous memory bank. Should the subscriber device require, for any reason, to restore the previously used software, it may switch the previous memory bank to the current memory bank and run the software on the newly labeled current memory bank.

Upgrade area 230 may be used to store the second code image while it is being downloaded. Using upgrade area 230 may ensure that partially downloaded software does not destroy the contents of either persistent memory banks.

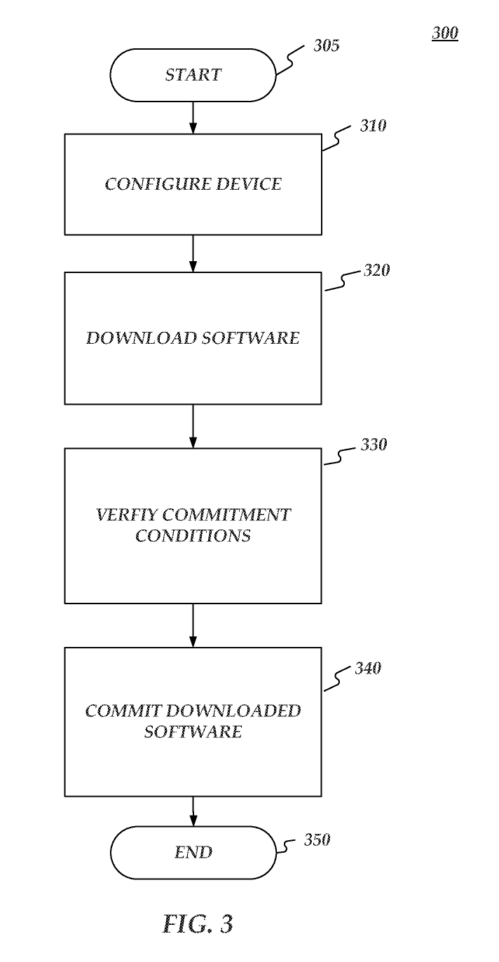

For example, upgrade area 230 may hold the downloaded second code image until subscriber device 120 is ready to commit the second code image. Once the second code image is ready to be committed, the second code image may be transferred, as will be detailed with respect to FIG. 3, to a persistent memory bank and operating module 235 may commit and activate the second code image for operating subscriber device 120. The persistent memory bank containing the activated second code image may be considered the current memory bank.

Operation module 235 may be configured to provide the various services and operations of both the first code image and second code image. For example, operation module 235 may configure subscriber device 120 in accordance with the first code image, while downloading, in parallel, the second code image to upgrade area 230. Operation module 235 may be further configured to install and commit the second code image and subsequently execute the functionality and services of the service provider software.

Accordingly, while executing on processing unit 210, operation module 230 may perform, for example, one or more stages from method 300 described below with respect to FIG. 3. Though subscriber device 120 is shown to have the aforementioned components, other components may be included in subscriber device 120 such as input/output components, display components, and other components.

FIG. 3 is a flow chart setting forth the general stages involved in a method 300 consistent with embodiments of the disclosure for committing software. Method 300 may be implemented using subscriber device 120 as described in more detail above with respect to FIGS. 1 and 2.

Method 300 may begin at starting block 305 and proceed to stage 310 where subscriber device 120 may be configured. Configuration may comprise, for example, a device provisioning and operating condition determination. During device provisioning, operation module 235, when executing the first code image, may cause subscriber device 120 to communicate with service provider headend 105 in order to authorize subscriber device 120 to receive services from the service provider. During communication with service provider headend 105, subscriber device 120 may receive, for example, a listing of approved programs, channels, and authorization codes for pay-per-view and video-on-demand services.

Furthermore, during configuration, the first code image may also check the operating conditions for subscriber device 120. For example, during configuration, operation module 235 may initiate several checks on subscriber device 120. These checks may include, but not be limited to, in-band signal strength, out-of-band signal strength, Internet Protocol connectivity, cable card functionality, coaxial and Ethernet cable connectivity, network bandwidth availability, among other operating environment checks.

From stage 310, where subscriber device 120 may be configured, method 300 may advance to stage 320 where subscriber device 120 may download second code image. Though method 300 shows subscriber device configuration taking place before the service provider software is downloaded, the download and configuration stages may occur in parallel. In this way, the second code image may be downloaded while subscriber device 120 is being configured in accordance with stage 310.

As discussed above, second code image may be downloaded to a specific portion of memory 215 in subscriber device 120, such as upgrade area 230. This may ensure that the first code image remains in operation while the second code image is being downloaded to subscriber device 120. Thus, operation module 235 may continue to operate the first code image located in first memory bank 220 and perform the configurations operations uninterrupted. Once downloaded, second code image may be installed and ready for commitment to first memory bank 220.

Commitment may comprise activating the second code image for operation on subscriber device 120. Unlike conventional systems, software commitment may not be automatic. This may avoid a number of problems presented by conventional automatic commitment. For example, device configuration may not be complete before service provider software is downloaded on the subscriber device. Since conventional systems commit the service provider software as soon as the software is downloaded, the service provider software would be executed even though the first code image has not indicated that the subscriber device was fit for receiving services from the service provider. Once the configuration is complete and all conditions have been verified, the service provider software may be committed. Such premature commitment may result in service provision under sub-optimal conditions resulting in later CPE 115 maintenance and repair.

In another example, a conventional system may download the second code image and then immediately commit the code but not reboot right away. The verification process may continue, but if the STB is reboot for any reason, including software error (reboot/crash) or AC power being cycled, the STB may execute the second code image after the reboot because it was already committed. This means, for example, an installer could unintentionally (or intentionally) bypass all the checks simply by waiting for the second image to download and then power cycling in conventional systems. Embodiments of the present disclosure, however, may avoid this by, even though the second code image has been downloaded, it may not have been committed. Only when the verification is complete (or bypass is performed) is the second image committed and then a reboot may be automatically performed.

In contrast, embodiments of the present disclosure may download the second code image, but await a commitment command to commit the second code image into operation. This may afford operation module 235 an opportunity to continue with the configuration process until completion, including rebooting the subscriber device, and resolve any quality issues prior to committing and activating the service provider software. In this way, subscriber device 120 may be properly configured prior to switching its software.

Once subscriber device 120 downloads the second code image in stage 320, method 300 may continue to stage 330 where subscriber device 120 may verify that subscriber device 120 is ready for second code image commitment. Operation module 235 may not give a commitment command until verification completes with satisfaction. For example, operating module 235 may check to see if the second code image has been successfully downloaded prior to commitment. In addition, operating module 235 may check to see that all the determinations in the configuration stage have been completed successfully. Satisfactory operating environment determinations may serve as conditions for software commitment.

If these commitment conditions did not result in satisfactory completion, remedial measures may be taken by, for example, a service technician installing subscriber device 120 on CPE 115. In various embodiments, subscriber device 120 may be configured to prompt the technician with the unsatisfactory results. The technician may then address these issues and re-run the configuration process until a satisfactory verification is received.

Alternatively, the technician may elect to input a by-pass command, causing operation module 235 to by-pass the verification process for subscriber device 120 and proceed straight to service provider software commitment. The by-pass command may be comprised of a key-sequence received at an input component of subscriber device 120. The by-pass command may require an authorization code from a supervisor or other entity that must approve bypassing the validation step. The authorization code may be entered locally on subscriber device 120 or may be created remotely and transmitted to subscriber device 120 without direct subscriber device 120 interaction.

In various embodiments, a time limit may be placed for device configuration. For instance, after a particular time period has elapsed, such as seven minutes, configuration may cease and subscriber device 120 may provide the configuration results. At this point, the technician may determine whether further subscriber device configuration and verification is necessary or whether subscriber device 120 is ready for commitment.

After subscriber device 120 verifies that subscriber device 120 is ready for second code image commitment in stage 330, method 300 may proceed to stage 340 where subscriber device 120 may commit the second code image. Commitment may commence upon operating module 235 issuing a commitment command in response to a satisfactory verification in stage 330. Commitment may comprise a transition from factory software (initially in operative control of subscriber device 120) to second code image (gaining operative control of subscriber device 120 upon commitment and activation).

Once the commitment command is issued, the second code image may be activated upon a power-cycle of subscriber device 120. The power-cycle may be triggered by the commitment command. It should be noted that, unlike conventional systems, unless the commitment command is provided, a power-cycle of the subscriber device 120 may not cause newly downloaded code (i.e., second code image) to activate and execute. When a commit has been performed, at the next boot, subscriber device 120 may see valid code in upgrade bank 230 and may see that it has been committed. At this point, subscriber device 120 may copy the second code image from upgrade bank 230 to a persistent memory bank and label the persistent memory bank as the current memory bank. Consequently, the original current memory bank becomes the previous memory bank.

Consistent with embodiments of the disclosure, the first code image and the second code image may be similar. In other words, some portions of the code in the first code image and the second code image may be the same. Consequently, only that portion that is different may be downloaded. The downloading process may determine the delta between what exists on, for example, subscriber device 120 and what should be on subscriber device 120. Then only the differences may be replaced. Embodiments of the disclosure may have the ability to define the smallest amount of software that can be replaced.

Executing the second code image, operation module 235 may be ready to provide the subscriber services in accordance with the configurations established by the factory software. Should it be necessary (due to, for example, corruption, failure, or other changes to the operating environment), operation module 235 may access to the previous persistent memory bank and restore and run the first code image to re-configure subscriber device 120. In this scenario, subscriber device 120 may again flow through the stages of method 300.

In addition, as mentioned above, commitment may not be contingent on satisfaction of the commitment conditions. Rather, the technician may issue the by-pass command, thereby triggering software commitment without, for example, a successful completion of subscriber device configuration. Once subscriber device 120 commits the second code image in stage 340, method 300 may then end at stage 350.

An embodiment consistent with the disclosure may comprise a system for committing software. The system may comprise a memory storage and a processing unit coupled to the memory storage. The processing unit may be operative to configure a subscriber device using a first code image; download a second code image; verify that the subscriber device is properly configured; and commit the second code image to the subscriber device.

Another embodiment consistent with the disclosure may comprise a system for committing software. The system may comprise a memory storage and a processing unit coupled to the memory storage. The processing unit may be operative to operate a subscriber device using a first code image; download a second code image; verify that the subscriber device is properly configured; commit, upon verification of the operating conditions, the second code image; and operate, upon commitment of the second code image, the subscriber device using the second code image.

Yet another embodiment consistent with the disclosure may comprise a system for committing software. The system may comprise a memory storage and a processing unit coupled to the memory storage. The processing unit may be operative to receive authorization for service provision from a service provider, check a set of operating conditions, download software from the service provider, verify that the set of operating conditions is met, and commit the downloaded software in response to verification that the plurality of operating conditions are met.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the disclosure, for example, are described above with reference to block diagrams and/or operational illustrations of methods, systems, and computer program products. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
configuring a subscriber device using a first code image;
downloading a second code image;
verifying that the subscriber device is properly configured; and
committing, in response to verifying that the subscriber device is properly configured, the second code image to the subscriber device.

2. The method of claim 1, wherein configuring the subscriber device comprises receiving authorization, from a service provider, for the subscriber device to receive services from the service provider.

3. The method of claim 1, wherein verifying that the subscriber device is properly configured comprises determining whether an operating environment associated with the subscriber device is within satisfactory operating standards.

4. The method of claim 3, wherein determining whether the operating environment associated with the subscriber device is within the satisfactory operating standards comprises determining whether the subscriber device satisfies a plurality of conditions.

5. The method of claim 4, wherein determining whether the subscriber device satisfies the plurality of conditions comprises checking at least one of the following: in-band signal strength, out-of-band signal strength, Internet Protocol connectivity, CableCARD functionality, coaxial cable connectivity, Ethernet cable connectivity, and network bandwidth availability.

6. The method of claim 4, wherein verifying that the subscriber device is properly configured comprises verifying that the subscriber device satisfies the plurality of conditions.

7. The method of claim 1, wherein configuring the subscriber device using the first code image comprises configuring the subscriber device using the first code image comprising at least one of the following: an operating software, at least one device driver, and at least one application for operating the subscriber device.

8. The method of claim 7, wherein downloading the second code image comprises downloading additional software not within the first code image.

9. The method of claim 1, wherein verifying that the subscriber device is properly configured comprises verifying that the subscriber device is properly configured within a predetermined period of time.

10. The method of claim 1, wherein downloading the second code image comprises downloading the second code image from a service provider, the second code image being operative to enable the subscriber device to receive subscriber services from the service provider.

11. The method of claim 1, wherein configuring the subscriber device and downloading the second code image occur in parallel.

12. A computer-readable device comprising a set of instructions which when executed performs a method comprising:
operating a subscriber device using a first code image;
downloading a second code image;
verifying that the subscriber device is properly configured;
committing, in response to verification of the operating conditions, the second code image; and
operating, upon commitment of the service provider software, the subscriber device using the second code image.

13. The computer-readable device of claim 12, wherein operating the subscriber device using the first code image comprises configuring the subscriber device to receive services from a service provider.

14. The computer-readable device of claim 13, wherein configuring the subscriber device to receive the services from the service provide comprises receiving authorization, from the service provider, to receive those services that a subscriber of the subscriber device is registered to receive.

15. The computer-readable device of claim 13, wherein verifying that the subscriber device is properly configured comprises determining whether an operating environment associated with the subscriber device is within satisfactory operating standards.

16. The computer-readable device of claim 12, wherein downloading the second code image comprises only downloading software not within the first code image.

17. The computer-readable device of claim 13, wherein configuring the subscriber device and downloading the second software occur in parallel.

18. The computer-readable device of claim 12, wherein verifying that the subscriber device is properly configured comprises receiving a by-pass command.

19. The computer-readable device of claim 18, wherein performing the by-pass command requires an authorization.

20. The computer-readable device of claim 12, wherein verifying that the subscriber device is properly configured comprises verifying that the subscriber device is properly configured within a predetermined period of time.

21. An apparatus comprising:
a memory storage;
a processing unit coupled to the memory storage, the processing unit be configured to:
receive authorization for service provision from a service provider,
check a set of operating conditions,
download a code image from the service provider,
receive a command to commit the downloaded code image, and
commit the downloaded code image in response to the received command.

22. The apparatus of claim 21, wherein the set of operating conditions comprise at least two of the following: in-band signal strength, out-of-band signal strength, Internet Protocol connectivity, CableCARD functionality, coaxial cable connectivity, Ethernet cable connectivity, and network bandwidth availability.

23. The apparatus of claim 21, wherein the downloaded code image comprises at least one of the following: an operating system, at least one device driver, and at least one application.

24. The apparatus of claim 21, wherein the command is operative to cause the processing unit to commit the downloaded code image without having verified the operating conditions.

25. The apparatus of claim 21, wherein the downloaded code image comprises additional software that is not within a factory code image.

26. The apparatus of claim 21, wherein the processing unit is further configured to operate using the downloaded code image upon commitment of the downloaded code image and a reboot of the apparatus.
